(19) United States
(12) Patent Application Publication
(10) Pub. No.: US 2025/0153652 A1
(43) Pub. Date: May 15, 2025

(54) Automobile Roof Accessory Attachment

(71) Applicant: Truong Pham, West Covina, CA (US)

(72) Inventor: Truong Pham, West Covina, CA (US)

(21) Appl. No.: 18/945,293

(22) Filed: Nov. 12, 2024

Related U.S. Application Data
(60) Provisional application No. 63/547,952, filed on Nov. 9, 2023.

(51) Int. Cl. B60R 11/00

(52) U.S. Cl. CPC B60R 11/00; B60R 2011/005

(57) ABSTRACT

The present invention is an accessory to be attached to the roof of a motor vehicle. The roof accessory comprises an antler, a J-hook, and an attachment unit that is used to secure the antler to the roof. The attachment unit has a divot centrally located that bears a slot across the divot. The slot allows a J-hook with a screw column to come up through the slot, and be screwed into the bottom surface of the antler. The bottom surface of the antler has threading that connects with the threading on the screw column.

### FIELD OF THE INVENTION

The present invention relates generally to an automobile roof accessory attachment. More specifically, the present invention is an attachment assembly that can be installed to where the factory roof rack would be installed.

### BACKGROUND OF THE INVENTION

Many automobile owners install or attach accessories on the exterior roof for decoration purposes. The accessories can be easily attached to the exterior roof using adhesives. However, the adhesives may not be strong enough to hold the accessories for a long period or resist wind forces when the automobile moves.

An objective of the present invention is to provide automobile roof accessory attachments that can be installed on a roof of an automobile. Utilizing the present invention, any design of accessory can be installed on the roof of the automobile. The present invention is an assembly that comprises an accessory, a washer, a base, and a J-hook. However, the J-hook may be replaced with a bolt stud and a nut, or a bolt extension depending on the model of the automobile. Additional features and benefits are further discussed in the sections below.

### BRIEF DESCRIPTION OF THE DRAWINGS

FIG. 1 is an exemplary view of the present invention being installed on the roof of the automobile.

FIG. 2 is a front-left perspective view of the present invention.

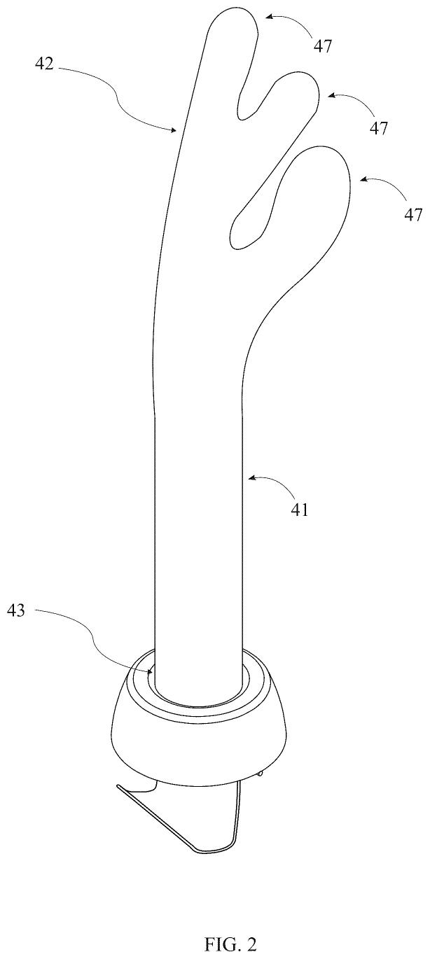

FIG. 3 is an exploded view of the present invention.

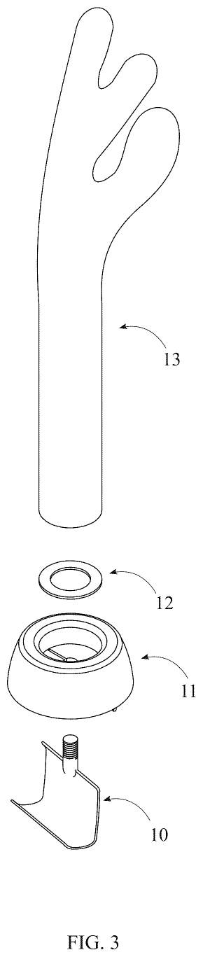

FIG. 4 is a front-left perspective view of the J-hook.

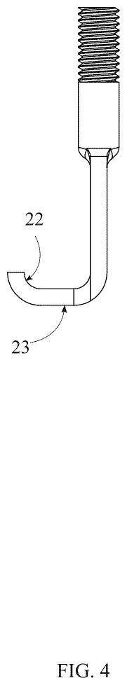

FIG. 5 is a front perspective view of the J-Hook.

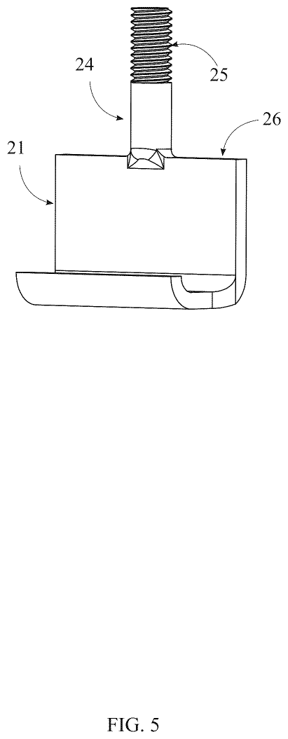

FIG. 6 is a bottom perspective view of the attachment unit.

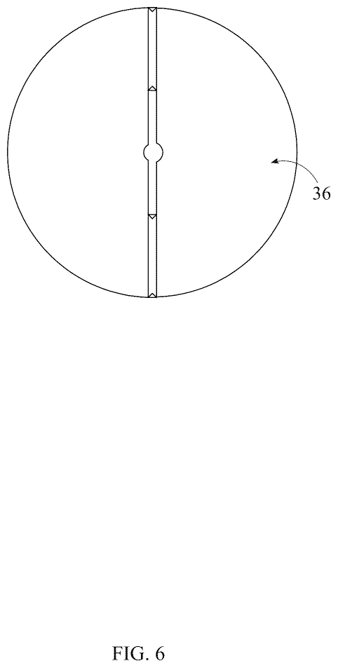

FIG. 7 is a top front perspective view of the attachment unit.

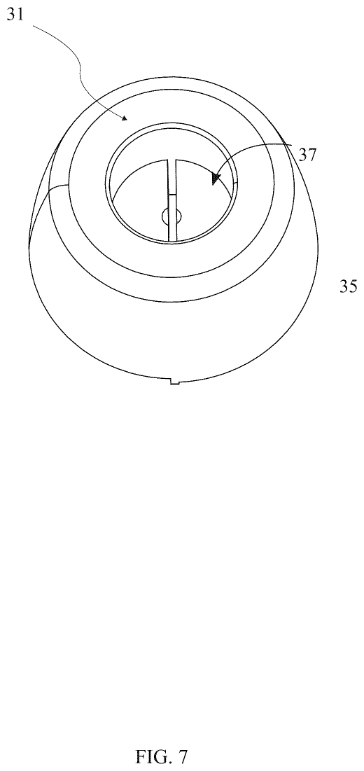

FIG. 8 is a top perspective view of the attachment unit.

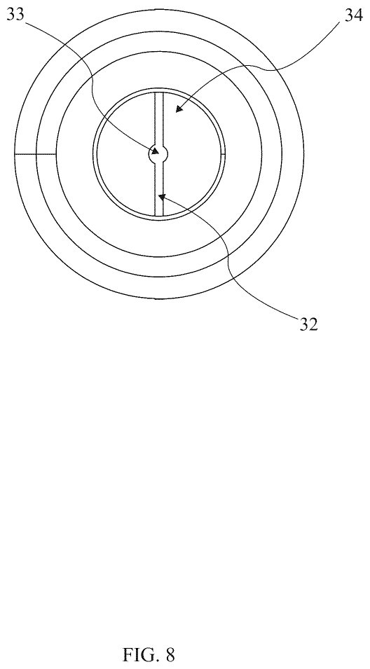

FIG. 9 is a bottom view of the antler.

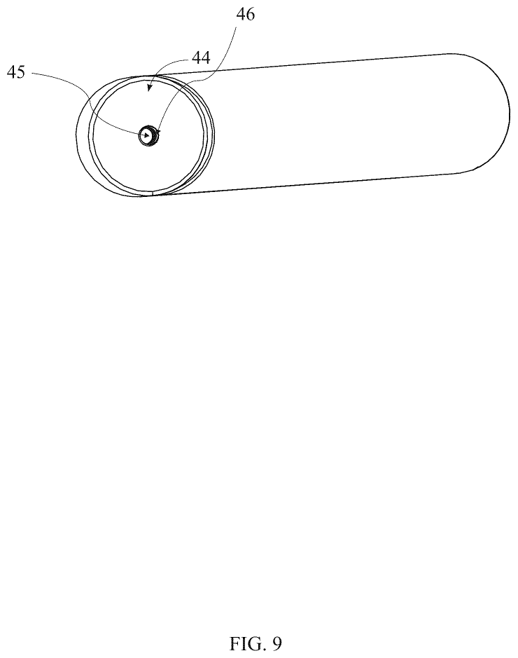

### DETAIL DESCRIPTIONS OF THE INVENTION

All illustrations of the drawings are for the purpose of describing selected versions of the present invention and are not intended to limit the scope of the present invention.

The present invention provides an automobile roof accessory attachment 1. As can be seen in FIG. X, the present invention is an assembly that can accommodate any design of accessory to be installed on a roof of an automobile. In a preferred embodiment, the present invention comprises an antler 13, a washer 12, an attachment unit 11, and a J-hook 10. As can be seen in FIGS. X and X, the antler 13 provides a design of an animals antler 13 however, any desired design may be used. The washer 12 prevents the antler 13 from loosening by distributing the J-hook's 10 load. The attachment unit 11 is configured to accommodate the antler 13, the washer 12, and the J-hook 10. The J-hook 10 acts as a fastener of the present invention. Further, the J-hook 10 is the component that makes a connection between the present invention and the roof of the automobile.

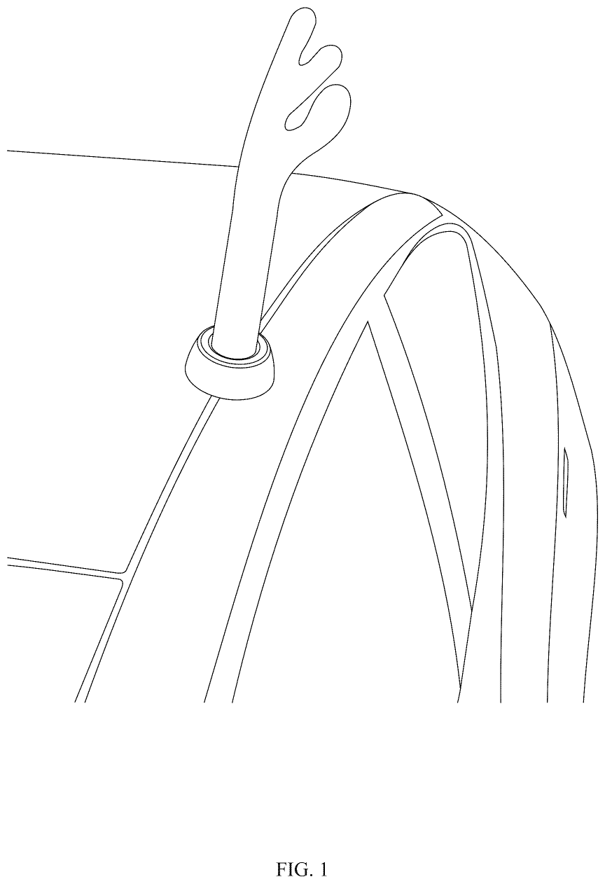

The antler 13 comprises a central upright 41 and a foundation 44. The central upright 41 is the main core of the antler 13 that has a plurality of limbs 47 extending outward angularly from it. The central upright 41 is centrally positioned over the washer 12 when in use and it is lowered into a divot 37 found within the attachment unit 11. The antler 13 is cylindrical in shape, though can be made in any shape that maintains the function of the invention. The central upright 41 has a proximal end 43 and a distal end 42. The foundation 44 is the base located at the proximal end 43 of the central upright 41. The foundation 44 has a foundation aperture 45, which is a threaded hole. As can be seen in FIG. 1, the antler 13 provides a cylindrical structure with an animals antler design, although any desired design that can be accommodated to the attachment unit 11 may be used. The bottom surface of the antler 13 comprises a threaded hole. The threaded hole is configured to accept the threaded portion of the J-hook 10. The washer 12 provides a thin disk-like structure that has the same size as the bottom surface of the antler 13.

The attachment unit 11 provides a tapered cylinder structure with rounded edges. The attachment unit 11 comprises a housing 31. The housing 31 further comprises a divot 37, which is a circular indentation on the top center surface that can accommodate the washer 12 and the central upright 41 of the antler 13. The attachment unit 11 further comprises a slot 32 below the divot 37 that can accept the J-hook 10. The attachment unit 11 comprising an external surface 35 and a bottom surface 36. The housing 31 also contains a resting shelf 34 which is diametrically positioned within the divot 37. The divot 37 is centrally positioned on the housing 31.

The housing 31 is cylindrical in shape and is wider at the bottom and narrower at the top. The central upright 41 is smaller in diameter than that of the divot 37, which allows the central housing 31, along with the washer 12 to be placed inside the divot 37 and sit on the resting shelf 34. The resting shelf 34 bears a slot 32 which traverses the diameter of the resting shelf 34. The slot 32 also traverses into the bottom surface of the housing 31. Traversing through the central shelf is a central aperture 33. This central aperture 33 allows the J-hook 10 to come up through the slot 32 and into the threaded hole contained on the foundation 44 of the antler 13.

As can be seen in FIG. X, the J-hook 10 provides a J-shaped hook with a threaded rod. The J-shaped hook allows secure installation on the roof of the automobile. However, the J-hook 10 may be replaced with a bolt stud and a nut, or a bolt extension depending on the model of the automobile. The J-hook 10 is formed with a back panel 21, a bottom panel 23 that is curved, and a lip 22. The J-hook 10 also has a central support column. The central support column is a screw like feature that has a plurality of threading 25, allowing it to be threadedly attached to the antler 13 by way of the threaded hole in the foundation 44.

The back panel 21 has an upper edge 26. It is from the upper edge 26 that the central support column 24 extends upward. The central support column 24 is located in the center of the upper edge 26. The bottom panel 23 is curvedly connect to the back panel 21. The lip 22 connects to the back panel 21 opposite the bottom panel 23.

Although the invention has been explained in relation to its preferred embodiment, it is to be understood that many other possible modifications and variations can be made without departing from the spirit and scope of the invention.

What is claimed is:

1. A roof accessory comprising:
a J-hook;
an attachment unit;
the attachment unit comprising a housing;
an antler;
the antler comprising a central upright and a foundation; and
a plurality of limbs extending angularly from the central upright.

2. A roof accessory as claimed in claim 1 comprising:
a washer;
the central upright being centrally positioned on the washer; and
the central upright being cylindrical in shape.

3. A roof accessory as claimed in claim 1 comprising:
the central upright having a proximal end and a distal end;
the foundation being located on the proximal end of the central upright; and
a foundation aperture centrally located on the foundation.

4. A roof accessory as claimed in claim 1 comprising:
the housing having an external surface, and internal surface, and a bottom surface;
the housing comprising a divot and a resting shelf;
the resting shelf being diametrically positioned within the divot; and
the divot being central on the housing;

5. The roof accessory as claimed in claim 4 comprising:
the housing being cylindrical in shape; and
the central upright being smaller in diameter than the divot.

6. A roof accessory as claimed in claim 4 comprising
the resting shelf comprising a slot;
the slot traversing diametrically across the resting shelf;
the slot traversing through the resting shelf; and
the slot traversing into the bottom surface of the housing.

7. A roof accessory as claimed in claim 4 comprising:
a central aperture; and
the central aperture traversing through the resting shelf.

8. A roof accessory as claimed in claim 1 comprising:
the j-hook comprising a back panel, a bottom panel, a lip and a central support column;
the back panel having an upper edge;
the back panel being curvedly attached to the bottom panel;
the lip being connected to the bottom panel opposite the back panel; and
the central support column extending upward from the center of the upper edge;

9. The roof accessory as claimed in claim 8 comprising:
the central support column having a plurality of threading.

10. A roof accessory comprising:
a J-hook;
an attachment unit;
the attachment unit comprising a housing;
an antler;
the antler comprising a central upright and a foundation;
a plurality of limbs extending angularly from the central upright; and
a washer.

11. A roof accessory as claimed in claim 10 comprising:
the central upright being centrally positioned on the washer;
the central upright being cylindrical in shape;
the central upright having a proximal end and a distal end;
the foundation being located on the proximal end of the central upright; and
a foundation aperture centrally located on the foundation.

12. A roller-type applicator cleaning apparatus as claimed in claim 10 comprising:
the housing having an external surface, and internal surface, and a bottom surface;
the housing comprising a divot and a resting shelf;
the resting shelf being diametrically positioned within the divot;
the divot being central on the housing;
the housing being cylindrical in shape; and
the housing being wider at the bottom and narrower at the top.

13. A roller-type applicator cleaning apparatus as claimed in claim 12 comprising:
the central upright being smaller in diameter than the divot;
the resting shelf comprising a slot;
the slot traversing diametrically across the resting shelf;
the slot traversing through the resting shelf;
the slot traversing into the bottom surface of the housing;
a central aperture; and
the central aperture traversing through the resting shelf.

14. A roof accessory as claimed in claim 1 comprising:
the j-hook comprising a back panel, a bottom panel, a lip and a central support column;
the back panel having an upper edge;
the back panel being curvedly attached to the bottom panel;
the lip being connected to the bottom panel opposite the back panel;
the central support column extending upward from the center of the upper edge; and
the central support column having a plurality of threading.
